(19) United States
(12) Patent Application Publication
(10) Pub. No.: US 2012/0189934 A1
(43) Pub. Date: Jul. 26, 2012

(54) FUEL CELL WITH MEANS FOR REGULATING POWER OUTPUT

(75) Inventor: Trong TRAN, Erlangen (DE)

(73) Assignee: DIEHL AEROSPACE GMBH, Uberlingen (DE)

(21) Appl. No.: 13/292,555

(22) Filed: Nov. 9, 2011

(30) Foreign Application Priority Data
Jan. 21, 2011 (DE) 10 2011 009109.2

(51) Int. Cl. H01M 8/04

(52) U.S. Cl. 429/443; 429/428

(57) ABSTRACT

A fuel cell is provided, with an anode device having a fuel inlet, a cathode device having an oxidizing agent inlet, and a membrane arranged between the anode device and the cathode device. The fuel cell has means for self-regulating the output power of the fuel cell, which counteract a reduction in output power or regulate output power substantially independently of the fuel cell service life and operating temperature. The means can have at least one bypass diode connected electrically to the anode device and the cathode device and/or at least one fuel feed device with a self-regulating fuel feed, which has a first thermally expansible element, and/or at least one oxidizing agent feed device with a self-regulating oxidizing agent feed, which has a second thermally expansible element.

### BACKGROUND OF THE INVENTION

The invention relates to a fuel cell according to the precharacterizing clause of Claim 1, with an anode device comprising a fuel inlet, a cathode device comprising an oxidizing agent inlet, and a membrane which is arranged between the anode device and the cathode device, and to a fuel cell unit with two or more fuel cells.

### DISCUSSION OF THE PRIOR ART

Such fuel cells are known per se and comprise an anode with a hydrogen inlet, a cathode with an oxygen inlet and a membrane arranged between the anode and the cathode. Such a fuel cell delivers an output voltage of approx. 1 volt. To achieve a higher voltage, two or more fuel cells are connected in series and packed together to form a fuel cell unit, which is also known as a stack due to the fact that the individual fuel cells are packed together substantially in a stack. Hydrogen in gaseous form (H₂) is supplied to a respective anode as fuel and oxygen in gaseous form (O₂) is supplied to a respective anode as oxidizing agent. The anode is supplied with hydrogen gas and the cathode with oxygen gas in each case substantially in parallel.

In a respective fuel cell the hydrogen (“fuel”) is oxidized catalytically on the anode with release of electrons to yield hydrogen ions (protons, H⁺). While the protons arising during oxidation find a path through the membrane to the cathode, the electrons arising during oxidation flow through an external circuit (or an external load resistance) to the cathode. At the cathode the oxygen (“oxidizing agent”) supplied is reduced to anions (O²⁻) by uptake of the electrons, which anions react immediately thereafter with the hydrogen ions (H⁺) to yield water (H₂O).

The hydrogen ions (protons, p1, p2, p3, see for example FIG. 1) arising at the anode of the respective fuel cell thus pass through the membrane of the fuel cell to the cathode of the same fuel cell and, in the presence of a stack with two or more identical fuel cells, are recombined with the anions (e2, e3, e1) which originate from an adjacent fuel cell arranged in the same stack or which have flowed through the external circuit. Such a fuel cell unit consisting of two or more identical fuel cells is at dynamic electrochemical equilibrium and delivers its maximum power.

Due to tolerances or fluctuations in the properties of the elements (anode, membrane, cathode) of the fuel cells in a series-connected fuel cell unit, the individual fuel cells are however not normally of exactly identical construction. In addition, the electrical output power of each fuel cell, and thereby to an equal extent also the output power of the fuel cell unit, decreases due to material fatigue or thermal stress at the cathode or anode over the course of its service life. The weakest of the fuel cells in terms of output voltage determines or restricts the total power of the fuel cell unit. Thus, in an unfavourable case failure of an individual fuel cell may lead to failure of the entire fuel cell unit.

### SUMMARY OF THE INVENTION

The object of the invention is to counteract the decline in output power of individual fuel cells during operation of a fuel cell unit.

This object is achieved by a fuel cell with an anode device comprising a fuel inlet; a cathode device comprising an oxidizing agent inlet; and a membrane arranged between the anode device and the cathode device.

According to the invention, the fuel cell comprises means for self-regulating the output power of the fuel cell, which counteract a reduction in output power or regulate the output power substantially independently of fuel cell service life and operating temperature.

According to a first aspect, the means according to the invention are means for self-regulating the output power. This means that no regulating device which is external or based on targeted measurement of operating parameters of the fuel cell is needed, so limiting additional complexity or additional costs in producing a fuel cell according to the invention.

According to a second aspect, the means according to the invention are designed to regulate output power substantially independently of fuel cell service life and operating temperature. The service life of a fuel cell cannot of course be adjusted to a constant value during operation, but rather advances continuously, and with it also material fatigue phenomena at the cathode device or the anode device and a resultant reduction in output power. The operating temperature of the fuel cell and the resultant thermal stress suffered by the anode and cathode devices is an operating parameter which is difficult to detect, the influence of which cannot be determined in advance and which it is virtually impossible to control, because operating temperature depends inter alia on ambient conditions, including the ambient temperature at the place of operation and the output power, in particular the output current, of the fuel cell or a series-connected arrangement of fuel cells (i.e. a fuel cell unit). According to the second aspect, the means according to the invention provide a remedy for the above-stated problems.

In the fuel cell, the fuel inlet may be a hydrogen inlet and the oxidizing agent inlet an oxygen inlet.

In a first embodiment, the means for self-regulating the output power comprise a bypass diode connected electrically to the anode device and the cathode device.

The first embodiment is based on the inventors' realization that when the fuel cell is in operation the volumetric flow rate of the hydrogen ions (protons) through the membrane is a measure of the power or performance of the fuel cell. If the flow rate of the protons is disrupted (reduced), such as for instance if the membrane is wetted with water, then an excess of hydrogen ions arises in the affected fuel cell at the anode device and an excess of anions at the cathode device. Consequently the electrical output voltage of the affected fuel cell falls. In this respect, a bypass diode connected electrically in parallel to the fuel cell provides a remedy, in that the bypass diode makes it possible for the excess electrons to pass through the bypass diode to the anode device and there recombine with the protons, whereby the electrical current (output current) is balanced in a self-regulating manner and the electrodynamic equilibrium between the serially connected fuel cells in the fuel cell unit re-established.

Although parallel connection of a bypass diode to each fuel cell of a fuel cell unit does cause the output voltage of the unit to fall, the output current nonetheless remains constant (over time and over the fuel cells). Without a bypass diode both the output voltage and the output current would decline over the course of the service life. In the worst case, this could lead to total failure of a fuel cell and thus of the entire fuel cell unit. Parallel connection of the bypass diodes results in a significantly slower decrease in power over the service life than without bypass diodes.

The bypass diode is preferably connected such that its conducting direction points from the anode device to the cathode device.

In particular, each bypass diode comprises a first and a second terminal, the first terminal being connected electrically conductively to the anode device and the second terminal to the cathode device.

In a second embodiment the means for self-regulating the output power may comprise a fuel feed device with a self-regulating fuel feed and/or an oxidizing agent supply device with a self-regulating oxidizing agent feed.

The second embodiment is based on the inventors' realization that when the fuel cell is in operation the membrane is its “weakest link”. Irrespective of its embodiment, each membrane has a maximum operating temperature, which must not be exceeded if functionality of the membrane is to be ensured. The stacked structure of a fuel cell unit would make it difficult to ensure both uniform cooling of the membranes of the fuel cells and regulated gas feed (fuel and oxidizing agent feed) to the individual fuel cells. Experience shows that the fuel cells arranged in the middle of a fuel cell unit (or a stack) reach the highest operating temperatures.

The self-regulating fuel feed may be formed by a first thermally expansible element and the self-regulating oxidizing agent feed by a second thermally expansible element. The first and/or the second thermally expansible element may comprise thermally expansible beads, which are each arranged in an internal volume which is substantially temperature-independent. The first thermally expansible element is designed to effect temperature-dependent regulation of an effective inlet cross-section of the fuel inlet. The second thermally expansible element may likewise effect temperature-dependent regulation of an effective inlet cross-section of the oxidizing agent inlet.

The fuel feed device may be designed to reduce fuel feed if the operating temperature of the fuel cell increases relative to a nominal fuel cell operating temperature and to increase it if the operating temperature falls. Likewise, the oxidizing agent supply device may be designed to reduce oxidizing agent feed if the operating temperature of the fuel cell increases relative to a nominal fuel cell operating temperature and to increase it if the operating temperature falls.

The means for self-regulating the output power may comprise at least one bypass diode connected electrically to the anode device and the cathode device and/or at least one fuel feed device with a self-regulating fuel feed and one oxidizing agent feed device with a self-regulating oxidizing agent feed.

According to a further aspect, a fuel cell unit with two or more fuel cells is also provided, each fuel cell comprising the following: an anode device with a fuel inlet, a cathode device with an oxidizing agent inlet, and a membrane arranged between the anode device and the cathode device.

According to the invention, at least one fuel cell of the fuel cell unit (i.e. of the stack) comprises means for self-regulating the output power of the fuel cell which counteract a reduction in the output power or regulate the output power substantially independently of fuel cell service life and operating temperature.

The means for self-regulating the output power may comprise at least one bypass diode connected electrically to the anode device and the cathode device and/or at least one fuel feed device with a self-regulating fuel feed, which may for example comprise a first thermally expansible element, and/or an oxidizing agent feed device with a self-regulating oxidizing agent feed, which may for example comprise a second thermally expansible element.

Of the two or more fuel cells in the fuel cell unit, at least one is constructed as described above.

### BRIEF DESCRIPTION OF THE DRAWINGS

The invention is described in greater detail below by way of example with reference to embodiments of the invention illustrated in the attached figures, in which

FIG. 1 shows a fuel cell unit with a plurality of fuel cells according to a first embodiment;

FIG. 2 shows a fuel cell unit with a plurality of fuel cells according to a second embodiment; and

FIG. 3 shows a fuel cell unit with a plurality of fuel cells according to a third embodiment.

### DETAILED DESCRIPTION OF THE INVENTION

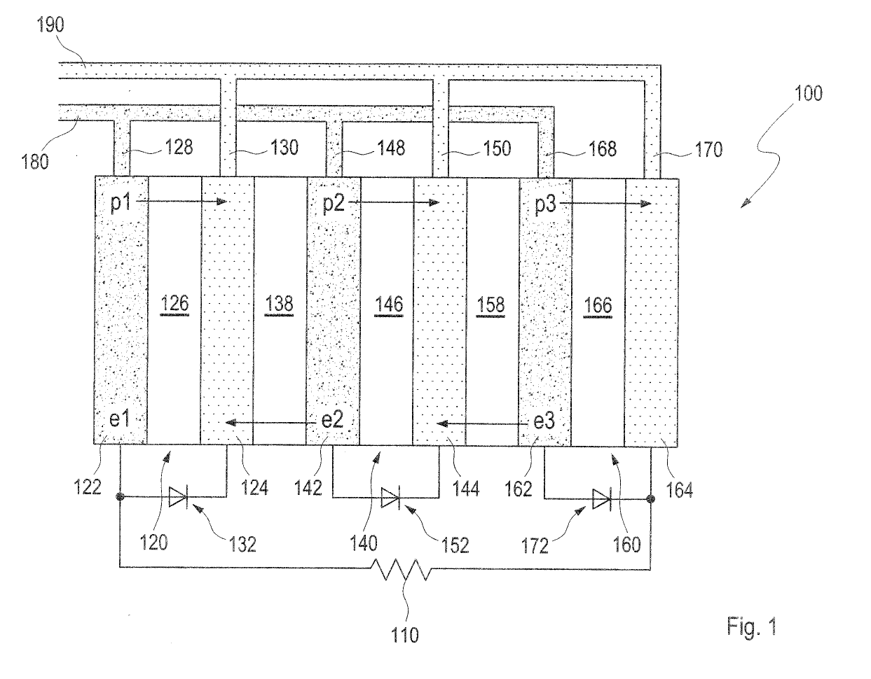

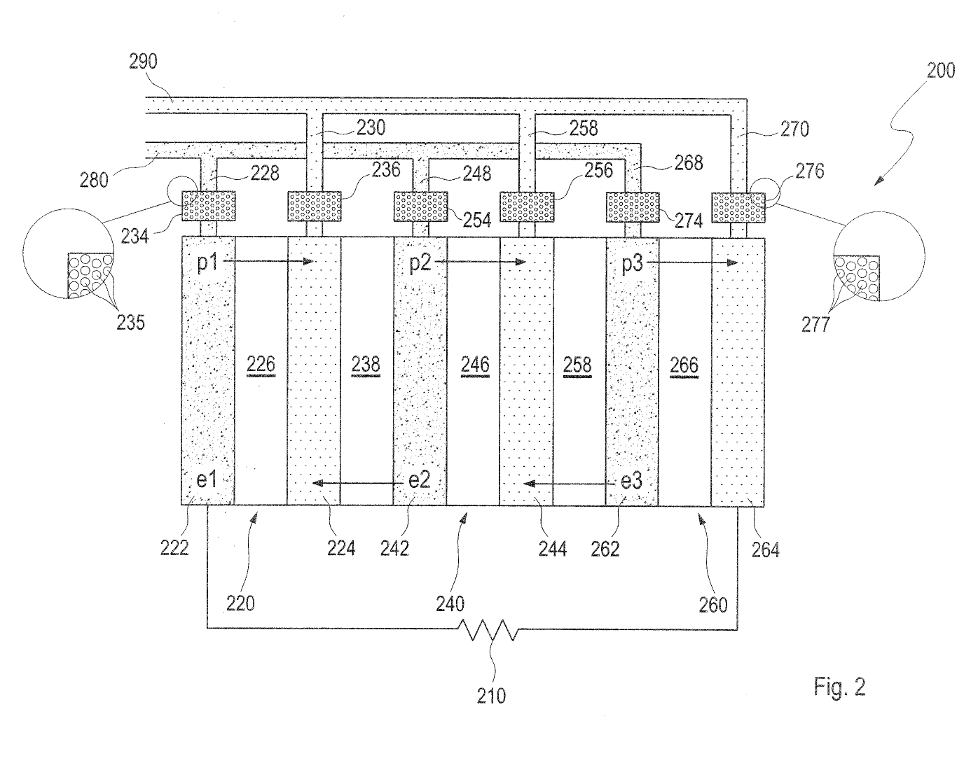

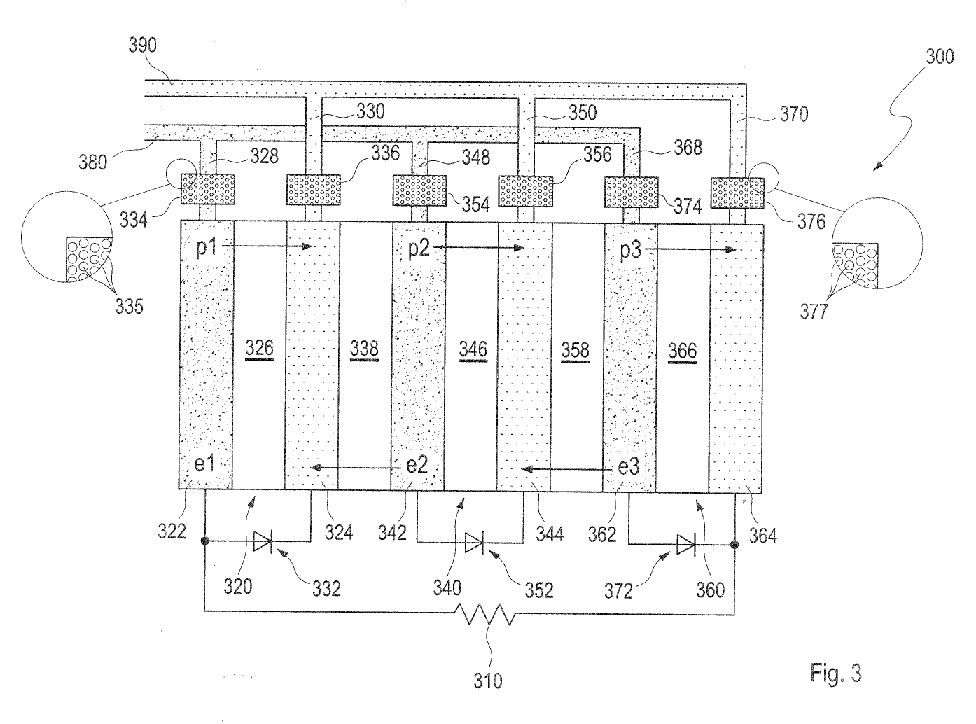

The reference numerals herein were selected as follows: The reference numerals of all the elements of the first embodiment of the fuel cell unit 100 shown in FIG. 1 start with a “1” in the hundreds place. The first, second and third fuel cells are labelled with the reference numerals 120, 140 and 160, differing in each case by 20. The reference numerals of the individual elements associated with the first, second and third fuel cells also accordingly differ in each case by 20. The latter is also true of the second and third embodiments of a fuel cell unit 200, 300 shown in FIGS. 2 and 3, for which it is further true that elements corresponding to those of the first embodiment shown in FIG. 1 respectively start with a “2” or “3” in the hundreds place in the second and third embodiments of the fuel cell unit 200 or 300 respectively, shown in FIGS. 2 and 3. In this connection, reference is also made to the list of reference signs at the end of the description.

In the fuel cell unit 100 according to a first embodiment with three fuel cells 120, 140, 160, as shown in FIG. 1, each of the three fuel cells 120, 140, 160 comprises an anode device 122, 142, 162 with an associated fuel inlet 128, 148, 168, a cathode device 124, 144, 164 with an associated oxidizing agent inlet 130, 150, 170, and a membrane 126, 146, 166 arranged between an anode of the anode device and the cathode of the cathode device. The three fuel cells 120, 140, 160 are stacked together in a stack arrangement. Between each pair of fuel cells 120 and 140 or 140 and 160 adjoining one another in the direction of stacking there is inserted an electrically conductive contact 138 or 158 respectively, which produces an electrically conductive connection between the cathode 124 or 144 respectively of the one adjacent fuel cell 120 or 140 and the anode 142 or 162 respectively of the respective other adjacent fuel cell 140 or 160 on the opposing side of the contact 138 or 158 respectively. Thus, an electrically conductive contact 138 is inserted between the cathode of the cathode device 124 of the first fuel cell 120 and the anode of the anode device 142 of the second fuel cell 140, and an electrically conductive contact 158 is likewise inserted between the cathode of the cathode device 144 of the second fuel cell 140 and the anode of the anode device 162 of the third fuel cell 160. The anode of the anode device 122 of the first fuel cell is connected electrically conductively via an external load resistance 110 or consumer unit to the cathode of the cathode device 164 of the third fuel cell 160.

The fuel inlets 128, 148, 168 of the first, second and third fuel cells 120, 140, 160 are connected jointly or in parallel to a common fuel feed 180 and are in fluid communication with one another. The fuel supplied to the anodes of the fuel cell is hydrogen in gaseous form (H₂). The oxidizing agent inlets 130, 150, 170 of the first, second and third fuel cells 120, 140, 160 are connected jointly or in parallel to a common oxidizing agent feed 190 and are in fluid communication with one another. The oxidizing agent supplied to the cathodes of the fuel cells is oxygen in gaseous form (O₂). A fuel cell supplied on the anode side with hydrogen gas as combustion fuel and on the cathode side with oxygen gas as oxidizing agent generates an electrical voltage of approx. 1 V. By stacking (with series connection) two or more, here three fuel cells 120, 140, 160 with conductive contacts arranged therebetween, an electrical series connection of these fuel cells is constructed, whose total output voltage corresponds to the sum of the output voltages of the individual fuel cells.

The volumetric flow rate of protons produced at the anode through the membrane to the cathode of a respective fuel cell is a measure of the performance thereof or of the output current thereof. If proton through-flow is disrupted, for example if the membrane is wetted with water, then an excess of hydrogen ions arises in the respective fuel cell in the case of the anode and an excess of anions (reduced oxygen ions) in the case of the cathode. Consequently, the electrical voltage generated in the respective fuel cell would fall. These processes, which reduce the power output of the fuel cell, are remedied according to one aspect of the invention in that a bypass diode 132, 152, 172 is connected in parallel to each fuel cell 120, 140, 160. The bypass diodes 132, 152, 172 are connected electrically by their respective electrical terminals in such a way to the fuel cell that the conducting direction of the bypass diode points from the anode to the cathode of the respective fuel cell. The conducting direction corresponds to the conducting direction of fictitious positive charge carriers; the direction of travel of the negative charge carriers (electrons) which are actually present points in the opposite direction, i.e. from the cathode through the bypass diode to the anode of the respective fuel cell. The excess electrodes pass through the bypass diode to the anode and there recombine with the protons. In this way, dynamic electrochemical equilibrium is re-established in the fuel cell and the electrical current through the fuel cell is balanced in a self-regulating manner. The total output voltage of the fuel cell unit 100 may indeed fall, but the total output current nonetheless remains constant. Without the bypass diodes, both the output voltage and the total output current would decline. In this respect, the bypass diodes 132, 152, 172 of the first embodiment of the fuel cell unit 100 constitute means according to a main claim of the invention for self-regulating the output power of the fuel cell, which counteract a reduction in output power or regulate output power substantially independently of fuel cell service life and operating temperature.

In the fuel cell unit 200 shown in FIG. 2 the three fuel cell units 220, 240, 260 have substantially the same internal structure and the same stacked arrangement as the fuel cells 120, 140, 160 of the first fuel cell unit 100 shown in FIG. 1.

The fuel cells 220, 240, 260 of the fuel cell unit 200 differ however from the fuel cells 120, 140, 160 of the fuel cell unit 100 in that in the case of the fuel cells 220, 240, 260 no bypass diodes are provided, but rather the fuel inlet 228, 248, 268 of a respective fuel cell comprises a fuel feed device 234, 254, 274 and the oxidizing agent inlet 230, 250, 270 of a respective fuel cell comprises an oxidizing agent feed device 236, 256, 276. Each fuel feed device 234, 254, 274 comprises an in each case substantially identical internal volume (not labelled), which is filled with thermally expansible beads as an embodiment of first thermally expansible elements 235, 255, 275 of the fuel feed device 234, 254, 274. The thermally expansible beads change their linear dimensions or their volume in proportion to the change in temperature or in proportion to the cube of temperature. If the temperature increases, the beads expand and thereby reduce the effective inlet cross-section for feed of the fuel (hydrogen gas, H₂) to the anode.

Likewise, the oxidizing agent feed devices 236, 256, 276 also each comprise identical, substantially temperature-independent internal volumes (not labelled), which are filled with thermally expansible beads as an embodiment of second thermally expansible elements 237, 257, 277. If the temperature rises, the thermally expansible beads 236, 256, 276 expand and thereby reduce the effective inlet cross-section for the supply of oxidizing agent (oxygen gas, O₂) to the cathode.

The thermally expansible beads as embodiments of the first or second thermally expansible elements 235, 255, 275 or 237, 257, 277 respectively of the fuel or oxidizing agent feeds bring about temperature-dependent regulation of the gas feed, which falls in a self-regulating manner if the temperature rises and rises in a self-regulating manner if the temperature falls. This counteracts the conventionally known reduction in power output of a fuel cell which arises as a function of fuel cell temperature. In this respect, the thermally expansible beads arranged in the internal volumes constitute a second embodiment of means according to a main claim of the invention for self-regulating the output power of the fuel cell, which counteract a reduction in the output power or regulate the output power substantially independently of fuel cell service life and operating temperature.

In the third embodiment shown in FIG. 3 of a fuel cell unit 300, the three fuel cells 320, 340, 360 and the stacked arrangement of the cells have an in each case substantially identical internal structure or an identical stack arrangement to the fuel cells 120, 140, 160 of the fuel cell unit 100 shown in Fig, 1.

Each of the fuel cells 320, 340, 360 shown in FIG. 3 comprises a bypass diode 332, 352, 372, which is connected in parallel to a respective fuel cell in the same way as the bypass diodes in the fuel cells 120, 140, 160 of the fuel cell unit 100 shown in FIG. 1. The bypass diodes 132, 152, 172 in the first embodiment of a fuel cell unit 100 or the bypass diodes 332, 352, 372 in the third embodiment of a fuel cell unit 300 constitute an embodiment according to a first aspect of the means according to the invention for self-regulating the output power of the fuel cells. The bypass diodes bring about a reduction in the output power, as described above.

Each of the fuel cells 320, 340, 360, shown in FIG. 3, of the fuel cell unit 300 also comprises in its fuel inlet 328, 348, 368 a fuel feed device 334, 354, 374, these being filled with thermally expansible beads as an embodiment of first thermally expansible elements 335, 355, 375, in a manner similar to the fuel feed devices 234, 254, 274 of the fuel cell unit 200 shown in FIG. 2. Each of the fuel cells 320, 340, 360 likewise comprises in its oxidizing agent inlet 330, 350, 370 an oxidizing agent feed device 336, 356, 376, these being filled with thermally expansible beads as an embodiment of second thermally expansible elements 337, 357, 377, in a manner similar to the oxidizing agent feed devices 236, 256, 276 of the fuel cell unit 200 shown in FIG. 2. The fuel feed devices 234, 254, 274 or 334, 354, 374 respectively, filled with the thermally expansible beads, of the fuel cell unit 200 or 300 respectively and the oxidizing agent feed devices 236, 256, 276 or 336, 356, 376 respectively, filled with the thermally expansible beads, of the second or third fuel cell unit 200 or 300 respectively constitute embodiments according to a second aspect of the means for self-regulating the output power of the fuel cell, which regulate output power substantially independently of fuel cell service life and operating temperature.

The mode of operation of the bypass diodes or of the fuel and oxidizing agent feed devices with the thermally expansible elements (beads) was described herein as self-regulating; it could also be described using the term “automatic” in the sense that the electrical output power of a fuel cell automatically, i.e. without the activity of any actively controlled means, keeps the output power of the respective fuel cell largely the same or constant.

### LIST OF REFERENCE SIGNS

100 Fuel cell unit

110 Load resistance

120, 140, 160 Fuel cell

122, 142, 162 Anode device

124, 144, 164 Cathode device

126, 146, 166 Membrane

128, 148, 168 Fuel inlet

130, 150, 170 Oxidizing agent inlet

132, 152, 172 Bypass diode

138, 158 Electrically conductive contact

180 Fuel feed

190 Oxidizing agent feed

200 Fuel cell unit

210 Load resistance

220, 240, 260 Fuel cell

222, 242, 262 Anode device

224, 244, 264 Cathode device

226, 246, 266 Membrane

228, 248, 268 Fuel inlet

230, 250, 270 Oxidizing agent inlet

234, 254, 274 Fuel feed device

235, 255, 275 First thermally expansible element

236, 256, 276 Oxidizing agent feed device

237, 257, 277 Second thermally expansible element

238, 258 Electrically conductive contact

280 Fuel feed

290 Oxidizing agent feed

300 Fuel cell unit

310 Load resistance

320, 340, 360 Fuel cell

322, 342, 362 Anode device

324, 344, 364 Cathode device

326, 346, 366 Membrane

328, 348, 368 Fuel inlet

330, 350, 370 Oxidizing agent inlet

332, 352, 372 Bypass diode

334, 354, 374 Fuel feed device

335, 355, 375 First thermally expansible element

336, 356, 376 Oxidizing agent feed device

337, 357, 377 Second thermally expansible element

338, 358 Electrically conductive contact

380 Fuel feed

390 Oxidizing agent feed

What is claimed is:

1. A fuel cell having an anode device comprising a fuel inlet,
a cathode device comprising an oxidizing agent inlet, for example an oxygen inlet, and
a membrane arranged between the anode device and the cathode device,
characterized by
means for self-regulating the output power of the fuel cell, which counteract a reduction in output power or regulate output power substantially independently of fuel cell service life and operating temperature.

2. The fuel cell according to claim 1, wherein the means for self-regulating the output power comprise a bypass diode connected electrically to the anode device and the cathode device.

3. The fuel cell according to claim 2, wherein the bypass diode exhibits a conducting direction from the anode device to the cathode device.

4. The fuel cell according to claim 2, wherein the bypass diode comprises a first and a second terminal, the first terminal being connected electrically conductively to the anode device and the second terminal to the cathode device.

5. The fuel cell according to claim 1, wherein the means for self-regulating the output power comprise a fuel feed device with a self-regulating fuel feed and/or an oxidizing agent feed device with a self-regulating oxidizing agent feed.

6. The fuel cell according to claim 5, wherein the self-regulating fuel feed comprises a first thermally expansible element and the self-regulating oxidizing agent feed comprises a second thermally expansible element.

7. The fuel cell according to claim 6, wherein the first and/or the second thermally expansible element comprises thermally expansible beads, which are in each case arranged in a substantially temperature-independent internal volume.

8. The fuel cell according to claim 7, wherein the first thermally expansible element brings about temperature-dependent regulation of an effective inlet cross-section of the fuel inlet and/or in that the second thermally expansible element brings about temperature-dependent regulation of an effective inlet cross-section of the oxidizing agent inlet.

9. The fuel cell according to claim 5, wherein the fuel feed device is designed to reduce fuel feed if the operating temperature of the fuel cell increases relative to a nominal fuel cell operating temperature and to increase it if the operating temperature falls and/or in that the oxidizing agent feed device is designed to reduce oxidizing agent feed if the operating temperature of the fuel cell increases relative to a nominal fuel cell operating temperature and to increase it if the operating temperature falls.

10. The fuel cell according to claim 1, wherein the means for self-regulating the output power comprise at least one bypass diode connected electrically to the anode device and the cathode device and/or at least one fuel feed device with a self-regulating fuel feed and one oxidizing agent feed device with a self-regulating oxidizing agent feed.

11. The fuel cell according to claim 1, wherein the fuel inlet is a hydrogen inlet.

12. The fuel cell according to claim 1, wherein the oxidizing agent inlet is an oxygen inlet.

13. A fuel cell unit with two or more fuel cells, each fuel cell comprising the following:
an anode device comprising a fuel inlet, for example a hydrogen inlet,
a cathode device comprising an oxidizing agent inlet, and
a membrane arranged between the anode device and the cathode device,
characterized in that
at least one fuel cell comprises means for self-regulating the output power of the fuel cell, which counteract a reduction in output power or regulate output power substantially independently of fuel cell service life and operating temperature.

14. The fuel cell unit according to claim 13, wherein the means for self-regulating the output power comprise at least one bypass diode connected electrically to the anode device and the cathode device and/or at least one fuel feed device with a first thermally expansible element and/or one oxidizing agent feed device with a second thermally expansible element.

15. A fuel cell unit with two or more fuel cells, at least one of which is constructed according to claim 1.

16. The fuel cell unit according to claim 13, wherein the fuel inlet is a hydrogen inlet.

17. The fuel cell unit according to claim 13, wherein the oxidizing agent inlet is an oxygen inlet.
